(19) United States
(12) Patent Application Publication
(10) Pub. No.: US 2024/0412309 A1
(43) Pub. Date: Dec. 12, 2024

(54) Machine-Learning to Predict Claim Outcomes

(71) Applicant: Schaefer City Technologies LLC, San Diego, CA (US)

(72) Inventors: Nathan COATES, Thornton, PA (US); Robert F. TYSON, JR., San Diego, CA (US); Denise M. TYSON, Los Angeles, CA (US)

(73) Assignee: Schaefer City Technologies LLC, San Diego, CA (US)

(21) Appl. No.: 18/429,098

(22) Filed: Jan. 31, 2024

Related U.S. Application Data
(60) Provisional application No. 63/442,419, filed on Jan. 31, 2023.

(51) Int. Cl. G06Q 50/18; G06N 20/00

(52) U.S. Cl. CPC G06Q 50/18; G06N 20/00

(57) ABSTRACT

Computing systems and methods, and non-transitory storage media, are provided for a machine learning or artificial intelligence model to output one or more predicted probabilities of potential claim outcomes in an open claim file that potentially results in a nuclear verdict during civil litigation, along with estimated pecuniary consequences of a potential verdict or settlement recorded.

### CROSS-REFERENCE TO RELATED APPLICATION

This application claims the benefit of U.S. Provisional Application No. 63/442,419, filed Jan. 31, 2023, and is hereby incorporated herein by reference in its entirety.

### FIELD OF THE INVENTION

This disclosure generally relates to systems and methods using machine learning to predict outcomes of claims and performing downstream decision making as a result of the predicted outcomes.

### BACKGROUND

Nuclear verdicts are jury verdicts and settlements in civil cases in which $10 million or more is awarded to the plaintiff, or in which the non-economic damages are grossly disproportionate to the economic damages. In recent years, the number of nuclear verdicts awarded has skyrocketed. For example, when considering verdicts of more than $1 million, the average verdict amount increased from $2.3 million to $22.3 million from 2010 to 2018. In 2019 alone, the number of verdicts that exceeded $20 million increased by 300 percent when compared to an average number of such verdicts between 2001 and 2010. This exponential rise in nuclear verdicts is detrimental not only for businesses and insurance companies, but also for preserving the rule of law, as faith in reasonable judgments is inevitably undermined by the proliferation of nuclear verdicts.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings. Any principles or concepts illustrated in one figure may be applicable to any other relevant figures. For example, principles illustrated in FIG. 1 may also be applicable to any of FIGS. 2A, 2B, and 3-5 and vice versa.

FIG. 1 illustrates an example implementation of a computing system that improves and executes predictions of potential outcomes stemming or resulting from a claim, summons, or complaint (hereinafter “claim”).

FIG. 2A illustrates that predictions by machine learning components and/or downstream actions resulting from the predictions may be constantly and/or dynamically updated following updates to data of a particular claim.

FIG. 2B illustrates additional information that is generated or derived from the predictions.

FIG. 3 illustrates a data preparation and transformation process in preparation for generating an output using the machine learning components.

FIG. 4 illustrates a training process of the machine learning components.

FIG. 5 illustrates a flowchart of an example method consistent with FIGS. 1, 2A, 2B and 3-4, embodied in a computing component.

FIG. 6 illustrates a summary of a process for creating and continuously improving the machine learning components.

FIG. 7 illustrates a block diagram of an example computer system in which any of the embodiments described herein may be implemented.

FIGS. 8A-8B illustrate an interface and an icon or badge showing an output of the predictions, in accordance with FIGS. 1, 2A, 2B and 3-6.

FIGS. 8C-8G illustrate an interface including analytics and/or metrics generated regarding predictions of claims.

### SUMMARY

A claimed solution rooted in computer technology overcomes problems specifically arising in the realm of computer technology, in particular, to outputting a prediction of one or more claim outcomes. In some embodiments, a system comprises one or more processors; and a memory storing instructions that, when executed by the one or more processors, cause the system to perform certain functions. These functions include receiving a query to predict one or more probabilities, which could also be represented by a scoring system, of potential claim outcomes; ingesting, from a database, a record of data regarding a claim; predicting, using one or more machine learning components, the one or more probabilities of the potential claim outcomes based on the record of data; and selectively implementing one or more actions based on the predicted one or more probabilities.

In some embodiments, the one or more probabilities indicate a probability of a nuclear verdict in favor of a plaintiff, and the instructions that, when executed by the one or more processors, cause the system to perform outputting a confidence level of the prediction of the one or more probabilities and one or more indicators of the predicted one or more probabilities, the indicators comprising factors or reasons corresponding to the one or more probabilities.

In some embodiments, the one or more actions comprise triggering an alert or a flag for further investigation. In some embodiments, the one or more actions comprise outputting one or more suggested strategies corresponding to the prediction of the one or more probabilities and the confidence level. The one or more actions may include transmitting an indication to trigger an alert or a flag to a different computing system. Additionally or alternatively, yet another separate computing system may output the one or more suggested strategies.

In some embodiments, the one or more actions comprise initiating a communication regarding a settlement and terms of the settlement to a different computing system associated with an opposing party.

In some embodiments, the machine learning components are trained sequentially by feeding, to the machine learning components, a first subset of data that comprises previously decided civil cases; and subsequently by feeding, to the machine learning components, additional data (e.g., a second subset of data) that comprises outcomes corresponding to the claim and other claims decided after the training using the first subset of data.

In some embodiments, the outcomes comprise scenarios in which the machine learning components predicted a nuclear verdict probability for a plaintiff in a particular civil proceeding, with at least a threshold probability or a threshold level, and an outcome of the particular civil proceeding was at least partially inconsistent with the prediction.

In some embodiments, the outcomes comprise scenarios in which the machine learning components predicted a nuclear verdict probability for a plaintiff in a particular civil proceeding, with less than a threshold probability or a threshold level, and an outcome of the particular civil proceeding was at least partially inconsistent with the prediction.

In some embodiments, the instructions further cause the system to perform: determining fields within the record of data to concatenate based on respective positions of the fields; and concatenating the fields, wherein the concatenating comprises combining text within the fields.

In some embodiments, the machine learning components comprise any of a boosted tree model, a decision tree, a neural network, or other machine learning or artificial intelligence model.

In some embodiments, the one or more probabilities indicate a probability of a non-nuclear verdict in favor of a defendant.

### DETAILED DESCRIPTION

In some implementations, a record of data including parameters or attributes of a particular claim, which may potentially proceed to trial, litigation, civil case, or proceeding, is fed into one or more machine learning components or models (hereinafter “components”). The machine learning components may output a prediction indicating a probability and/or a confidence level corresponding to the probability of a potential claim outcome or verdict (hereinafter “judgment”), such as a nuclear verdict. Here, a nuclear verdict may be a rendered judgment that is some amount greater than an amount of requested economic damages (e.g., more than one times the amount of requested economic damages). In some examples, the nuclear verdict may be defined as a rendered judgment that is at least four times the amount of requested economic damages, or any suitable integer or non-integer value. The probability may be manifested as a probability score (e.g., a range from 1-10 or any other suitable numerical range). In some examples, the confidence level may be based on an amount or an extent of available relevant information corresponding to a specific prediction. The probability and/or the confidence level may be updated, as existing information becomes updated or new information arrives, either in a bulk/batch process or continuously (e.g., using application programming interfaces (APIs) that interface to other data sources. In some examples, one or more different computing components, such as non-machine-learning components or classical computing components, may output one or more indicators or predicted indicators corresponding to the probability. These indicators may include, as nonlimiting examples, severity and/or jurisdiction. The indicators may be ranked. In some examples, the indicators may be provided only if the predicted probability exceeds a threshold level, and/or more indicators may be provided for higher probability levels. The classical computing components may include or implement classical mechanisms such as pivot tables and/or regression models. The outputting of the one or more indicators may be in parallel with the outputting of the prediction indicating the probability and/or the confidence level, as they may be performed by different computing components. The prediction may be used to make a decision or determination of a further action to be implemented, either manually or automatically. The decision may encompass facilitating, triggering, or causing a further review and/or a settlement of the case.

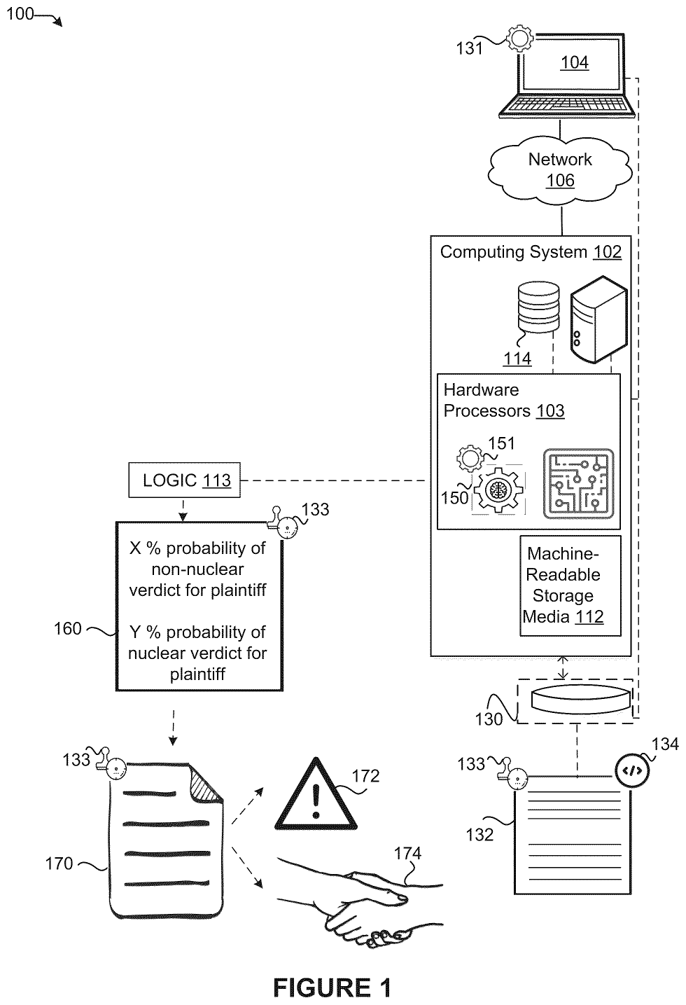

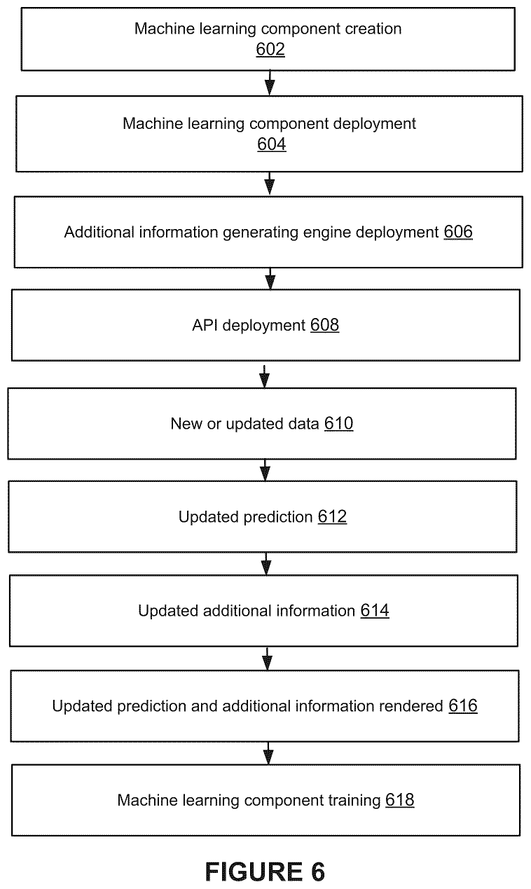

The machine learning components may be trained using one or more sets of training data, which may encompass previously decided civil cases, parameters or attributes of the previously decided civil cases, and/or decisions of the previously decided civil cases (e.g., a non-nuclear judgment in favor of the defendant, a nuclear judgment in favor of the plaintiff). The training may be based on historical data over a previous time window, as detailed, for example, in step 602 in FIG. 6. The training may include multiple stages. For example, in a first stage, a first subset of data including previously decided civil cases may be obtained or collected from a database, either manually or automatically. If the first subset of data includes unstructured data, this first subset may be transformed, manually and/or automatically by a computer, to create a modified first subset of data. The transformations to the first subset of data may include imputing missing entries, fields, or values (hereinafter “fields”), concatenating one or more fields of data, and/or promoting or demoting certain data fields (e.g., weighting certain fields less or more in importance, or disregarding certain fields). A first training set may include the untransformed first subset and/or the transformed first subset. Following the training of the machine learning components using the first training set, the machine learning components may generate one or more predictions. Additionally or alternatively, a second training set may be created for a second stage of training. The second training set may include the first training set, any outcomes of particular civil proceedings decided following the first stage of training, and/or any updates to the generated one or more predictions. In other words, the second training set may encompass feedback data. In one scenario, the machine learning components may have predicted a nuclear verdict for a particular claim, with at least a threshold probability or a threshold level (e.g., a medium or high probability or level of danger), and an outcome of the particular civil proceeding was at least partially inconsistent with the prediction (e.g., a non-nuclear judgment) the machine learning components may be retrained using data indicating that the particular claim returned a non-nuclear judgment. In other scenarios, the machine learning components may have predicted a nuclear verdict for a particular claim, with less than a threshold probability or a threshold level (e.g., a medium of low probability or level of danger), and an outcome of the particular civil proceeding was at least partially inconsistent with the prediction (e.g., a nuclear judgment). In such a manner, the machine learning components may be retrained using data indicating that the particular claim returned a nuclear judgment. These aspects will be illustrated in more detail in the subsequent FIGS. 1, 2A, 2B, and 3-5.

FIG. 1 illustrates an example implementation or scenario (hereinafter “implementation”) 100, of a computing system 102 that improves and executes predictions of potential claim outcomes in civil cases, such as, predictions of whether a nuclear verdict will occur and/or a probability of the nuclear verdict occurring.

The implementation 100 can include at least one computing device 104, which may be operated by an entity such as a user. The computing device 104 may have a platform, which may be manifested as a widget, that interacts with the computing system 102. The user or the computing device 104 may submit a request or query for a prediction and/or a probability of one or more particular trial outcomes through the computing device 104. Such a request or query may include data regarding a claim, such as an insurance claim, that may potentially progress to trial. The data may be manifested as a record or a case for each claim, and stored in a database 130.

In some examples, the computing device 104 may visually render any outputs generated from analysis or processing, and/or from the database 130. In general, the user can interact with the database 130 directly or over a network 106, for example, through one or more graphical user interfaces, application programming interfaces (APIs), and/or webhooks. The database 130 may be associated with the computing device 104, and may store the record of data 132. The computing device 104 may include one or more processors and memory.

The computing system 102 may include one or more processors 103 that may be configured to perform various operations by interpreting machine-readable instructions, for example, from a machine-readable storage medium 112. In some examples, one or more of the processors 103 may be combined or integrated into a single processor, and some or all functions performed by one or more of the hardware processors 103 may not be spatially separated, but instead may be performed by a common processor. The processors 103 may be physical or virtual entities. For example, as virtual entities, the processors 103 may be encompassed within, or manifested as, a program within a cloud environment. The computing system 102 may also include a storage 114, which may include a cache for faster access compared to the database 130. The computing system 102 may ingest, import, or otherwise take in data from the database 130 via one or more API endpoints 131.

The processors 103 may further be connected to, include, or be embedded with logic 113 which, for example, may include protocol that is executed to carry out the functions of the processors 103. In general, the logic 113 may be implemented, in whole or in part, as software that is capable of running on the computing system 102, and may be read or executed from the machine-readable storage media 112. The logic 113 may include, as nonlimiting examples, parameters, expressions, functions, arguments, evaluations, conditions, and/or code. Here, in some examples, the logic 113 encompasses functions of or related to processing or analysis of a record of data of a civil case. At least a portion of the logic 113 may be implemented by, or encapsulated as, one or more machine learning components 150. As summarized previously, the machine learning components 150 may ingest a record of data 132 regarding one or more pending civil cases, via one or more APIs 130, from the database 130, and predict probabilities 160 of certain occurrences such as a favorable verdict for a defendant, including a probability of a non-nuclear verdict for the defendant. The machine learning components 150 may include any models and/or techniques which may be supervised, such as, without limitation, neural networks, perceptrons, decision trees, random forest, Support Vector Machine (SVM), classification, Bayes, k-nearest neighbor (KNN), and/or gradient boosting such as XGBoost. Different machine learning components 150 may be utilized depending on a type or classification of a civil case. For example, gradient boosting models may be utilized for personal injury cases. Additionally or alternatively, one machine learning component, or a combination of machine learning components (e.g., an ensemble model) may be applied to a particular civil case. Additionally or alternatively, separate machine learning components may be applied to unstructured data and structured data. For example, one machine learning component may be applied to unstructured data and a different machine learning component may be applied to structured data.

The record of data 132 may have one or more timestamps 133 indicating times at which the record of data was obtained, corroborated, and/or ingested into the database 130. The record of data 132 may, additionally or alternatively, be associated with metadata 134. The record of data 132 may include, for example, any of information regarding jurisdiction, location (e.g., state or county), type or classification, type of injury alleged or documented, whether primary or secondary (e.g., life-altering injury, death), specific injuries (e.g., femur fracture), a degree or extent of recovery, recuperation, or rehabilitation resulting from the injuries (e.g., surgery), any noneconomic attributes or parameters such as consortium, a cause of an event, a standard under which a violation was alleged (e.g., negligence), amounts of current, past, and/or future medical, wage, or other damage claims, and an attorney of a plaintiff. The record of data 132 may be originated from different data sources. For example, one or more data sources may include lists of entities (e.g., businesses, persons, and/or places) that fulfill certain criteria, such as income criteria and/or historical data including propensity to litigate. A positive presence of an entity on a particular list may result in the machine learning components 150 changing (e.g., increasing) a probability score. The record of data 132 may include unstructured and/or structured data (e.g., tabular or other organized format). Unstructured data may encompass, for example, media, unstructured text, and/or digital scent files or manifestations. The metadata 134 may include, for example, any sources from which the record of data 132 was obtained, degrees of reliability and/or accuracy of the respective sources, and/or whether portions of the record of data 132 were corroborated.

In some examples, the logic 113 may process, transform, analyze, and/or convert a subset of the record of data 132 prior to feeding the record of data 132 into the machine learning components 150. For example, the logic 113 may convert certain data from a textual format to a numerical format, score, or binaries. As one particular example, the logic 113 may convert a state or county, or other location indicator, into a score. Additionally or alternatively, the logic 113 may classify certain data according to risk tiers, stratifications, or classifications. Such a classification may be based on historical data from a previous window, such as a ten year window, which may be dynamically updated as time passes. In some examples, recent historical data may be weighted more heavily compared to older historical data. As another example, the logic 113 may convert or translate free text, or a free form general narrative that includes manually written text, using latent class analysis and/or text mining. The latent class analysis and/or text mining may generate counts of words or phrases and produce a vector. Within a vector space, the vector may be broken down into clusters of topics or categories, such as “auto accident,” or “loss of leg,” based on a frequency of appearance of keywords and/or an absence of keywords. The topics or categories may be fed into the machine learning components 150, which may determine certain topics or categories as being associated with a higher probability of a nuclear verdict.

In some examples, the logic 113 may process, preprocess, synchronize, and/or normalize (hereinafter “preprocess”) both structured and unstructured data. Unstructured data may encompass, for example, media (e.g., images, videos, audio, digital smell files), unstructured text documents, geospatial data, data from internet of things (IoT) devices, and/or surveillance data. By preprocessing the data, the logic 113 may prepare different types or formats of data to be consistent, and/or be suitable or compatible with the machine learning components 150. The preprocessing of the data may encompass redacting, hiding, encoding, and/or translating of at least a portion of personally identifiable information (PII). As a result, the preprocessing expedites the outputting of predictions from the machine learning components 150, eliminates irrelevant information, prevents dissemination of sensitive information, mitigates or eliminates any errors of incorrect interpretation or understanding by the machine learning components 150, and conserves an amount of processing resources consumed overall and by the machine learning components 150. The machine learning components 150 would receive already prepared or preprocessed data.

The logic 113 may parse unstructured data by identification of entities within the unstructured data, including keywords, phrases, and/or topics. The logic 113 may, from the identified entities, generate a matrix of values corresponding to the identified entities. The logic 113 may feed the matrix of values into a specific machine learning component, of the machine learning components 150, that is equipped to handle unstructured data. Alternatively, the logic 113 may feed the matrix of values into a same machine learning component that handles structured data. Thus, in some examples, different machine learning components may process structured data as opposed to unstructured data. Separate outputs may be generated from the different machine learning components and combined or merged. In other examples, a same machine learning component may process both structured and unstructured data.

The logic 113 may, additionally or alternatively, feed the record of data 132 into one or more machine learning components 150, depending on attributes of the record of data 132 including classifications, categories and/or topics identified. For example, a classification of an assault claim may be fed into a different and/or additional machine learning component compared to a classification of a wage claim. Thus, a subset of the machine learning components 150 may be deployed depending on a classification. In such a manner, only the machine learning components 150 most tailored and/or relevant to a particular claim, or a classification thereof, may be actively deployed. As a result, computing resources may be conserved by avoiding unnecessary deployment of less relevant and/or less accurate computing components.

The machine learning components 150 may generate a prediction of a probability of a nuclear verdict, and/or other verdict types. At least a subset of the outputs of the machine learning components include an API endpoint 151 that interfaces with the hardware processors 103, the computing device 104, and/or an external computing system or server. For example, the computing device 104 may receive a prediction of the probabilities of a nuclear verdict, and other information such as a forecast or estimate of pecuniary implications of a nuclear verdict, and/or other verdicts, and/or an estimated settlement cost. The other information may be transmitted to the computing device 104 via HyperText Markup Language (HTML). The probabilities and other information may be rendered on the computing device 104, for example. The other information may be transmitted to the computing In particular, the probabilities 160, once outputted and/or transmitted to the hardware processors 103 (e.g., a particular processor or segment thereof) or an external computing system, may trigger an output of a suggestion 170 of an action to be implemented, in accordance with the record of data 132 having the timestamps 133. Such an action may include, for example, a flag or an alert 172, rerouting of a claim, and/or triggering or initiating a settlement 174, and may include particular terms of a proposed settlement. This action may be either manually or automatically implemented, for example, following approval or feedback from a user. The alert 172 may trigger an alarm or indication for further review. This further review may be conducted by an authorized official. Meanwhile, triggering or initiating a settlement may encompass any of indicating to an official to initiate a settlement, and/or transmitting a communication to an opposing party to propose a settlement and/or terms thereof.

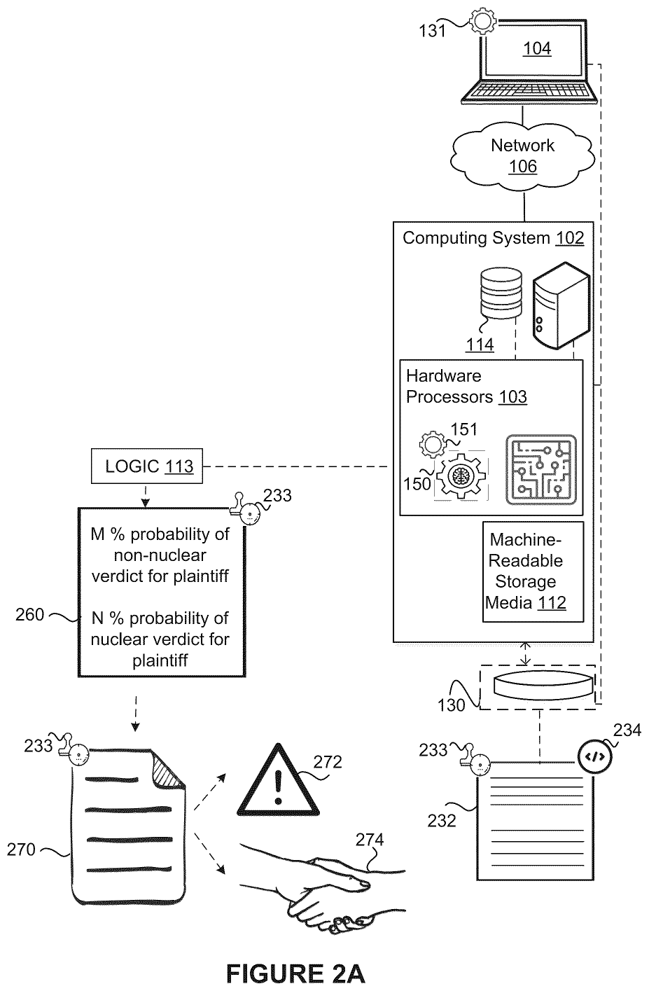

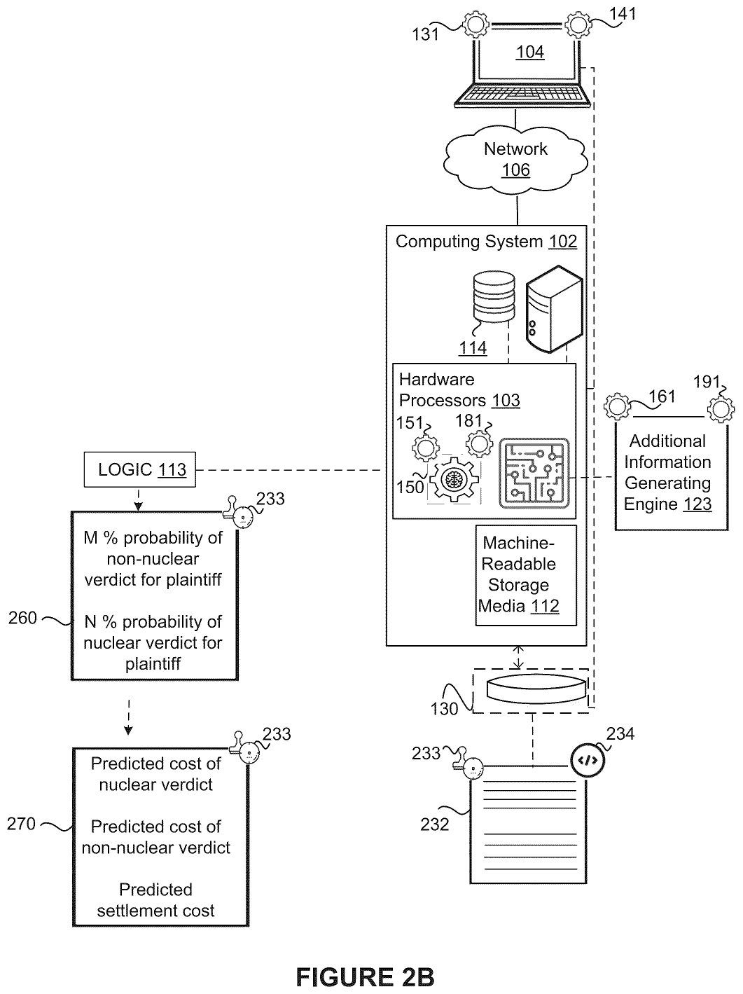

FIG. 2A illustrates that predictions by the machine learning components 150 and/or downstream actions resulting from the predictions may be constantly and/or dynamically updated following updates to the record of data 132 in FIG. 1. In particular, the record of data 132 may have been updated to a modified record of data 232 having one or more timestamps 233. For example, a previously missing or incomplete entry or field within the record of data 132 may have been updated or filled in, within the modified record of data 232. As another example, a previously filled in entry or field may have been updated, such as a field previously indicating no death may have been updated to indicate that a death did indeed occur, or a field previously indicating a death may have been updated to indicate that a death did not actually occur, but that a subject was in a coma. The modified record of data 232 may be fed into the machine learning components 150, via interaction between the API endpoints 131 and 151, and trigger activation of the computing system 102. The machine learning components 150 may infer or predict one or more updated probabilities 260 corresponding to the modified record of data 232 having the timestamps 233. The updated probabilities 260 may trigger an updated output or suggestion 270 of an action to be implemented, which may include a modified flag or alert 272, and/or a settlement 274.

FIG. 2B illustrates that an additional information generating engine 123, which may be encompassed within and/or associated with the hardware processors 103, may generate or derive additional information after receiving information regarding the one or more updated probabilities 260, or the one or more probabilities 160. The information generating engine 123 may receive, via interaction between API endpoints 161 and 191, the one or more updated probabilities 260, or the one or more probabilities 160. In particular, the additional information generating engine 123 may generate additional information 270, which may include a forecast or estimate of pecuniary implications of a nuclear verdict and/or other verdicts, and/or an estimated settlement cost. The additional information 270 may include a predicted cost of a nuclear verdict, a predicted cost of a non-nuclear verdict, and/or a predicted settlement cost. The additional information generating engine 123 may generate the additional information 270 based on one or more lookup tables and/or computations. The additional information generating engine 123 may have an API endpoint 161 that interfaces with an API endpoint 141 of the computing device 104, so that the additional information generating engine 123 may transmit the additional information 270 to the computing device 104.

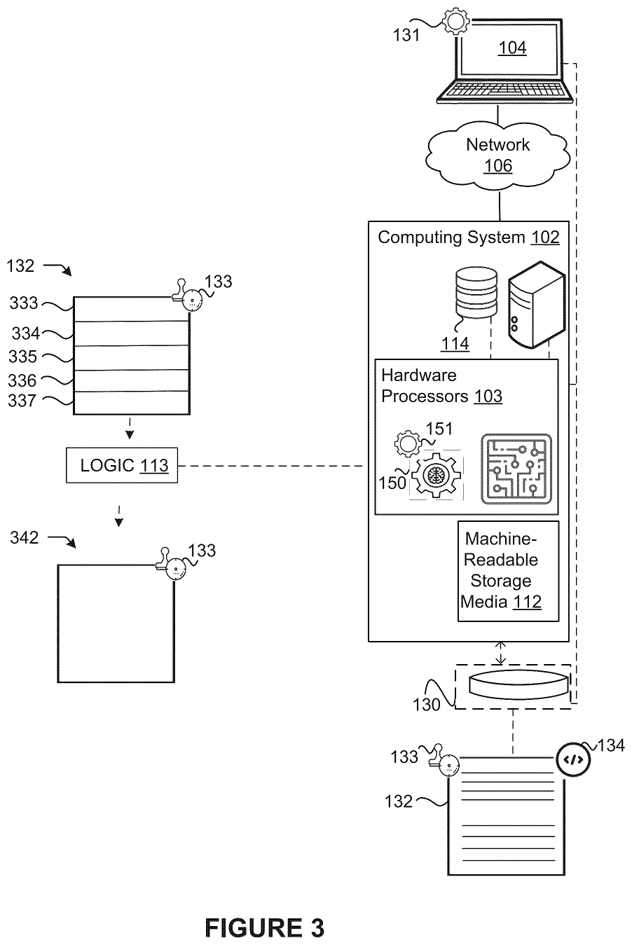

Particular fields or entries of the record of data 132 may be transformed in a data preparation process. In particular, in one example of data transformation as illustrated in FIG. 3, one or more fields 333, 334, 335, 336, and/or 337 within the record of data 132 may be concatenated or otherwise merged into a single field, such that the record of data 132 is transformed into a modified record of data 342. The concatenation may be based on relative positions of the one or more fields 333, 334, 335, 336, and/or 337 within the record of data 132. For example, a determination of which fields to concatenate may be based on relative locations of the fields. The data transformation may also encompass promoting (e.g., increasing an importance of, emphasizing, or highlighting) and/or demoting (e.g., lowering an importance of, deemphasizing, or disregarding) certain portions of the data. The transformation may, additionally or alternatively, encompass imputing and/or inferring any missing values or entries. The data transformation process may elucidate and/or contextualize certain data entries which were heretofore unclear or ambiguous.

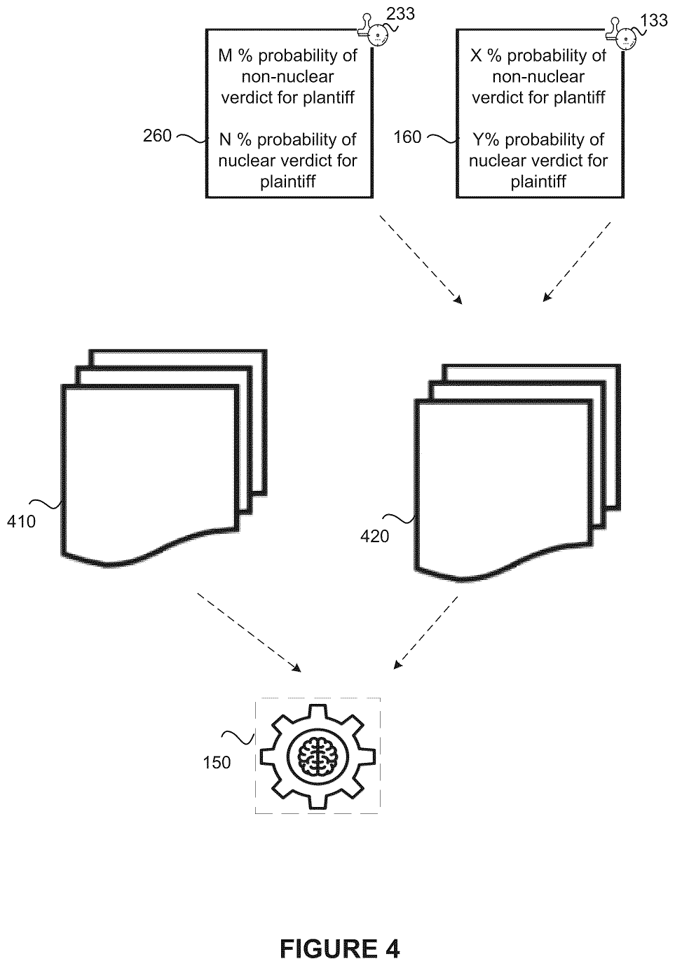

FIG. 4 illustrates that the machine learning components 150 may be trained sequentially using a first subset of data 410 and a second subset of data 420. The first subset of data 410 may encompass a first subset of data including previously decided claims obtained or collected in the database 130, either manually or automatically. The first subset of data may include transformed and/or untransformed data. For example, transformed data may be cleaned up and/or concatenated, in a same or similar process as that described in FIG. 3. Meanwhile, the second subset of data 420 may include the predictions 160, and/or the modified predictions 260, which may be augmented by one or more indications of whether the claims actually did result in a judgment or verdict for the plaintiff, and/or a nuclear verdict for the plaintiff, in the event that the claims actually went to trial. Thus, the machine learning components 150 may be trained using feedback of actual occurrences or results, and a comparison between the predictions 160 and actual occurrences, or between the modified predictions 260 and actual occurrences. For example, if the machine learning components 150 predicted a nuclear verdict for a particular claim, but that particular claim actually returns a non-nuclear verdict, the machine learning components 150 may be retrained using updated data indicating that the particular claim returned a non-nuclear verdict, thereby improving and iterating on the machine learning components 150. As another example, if the machine learning components 150 predicted a non-nuclear verdict for a particular claim, but that particular claim actually returns a nuclear verdict, the machine learning components 150 may be retrained using updated data indicating that the particular claim returned a nuclear verdict. Additionally, any prediction, such as a probability of a claim returning a nuclear verdict (e.g., 75% probability of a claim returning a nuclear verdict) may be corroborated and/or strengthened by feedback indicating an actual result of whether a claim returns a nuclear verdict.

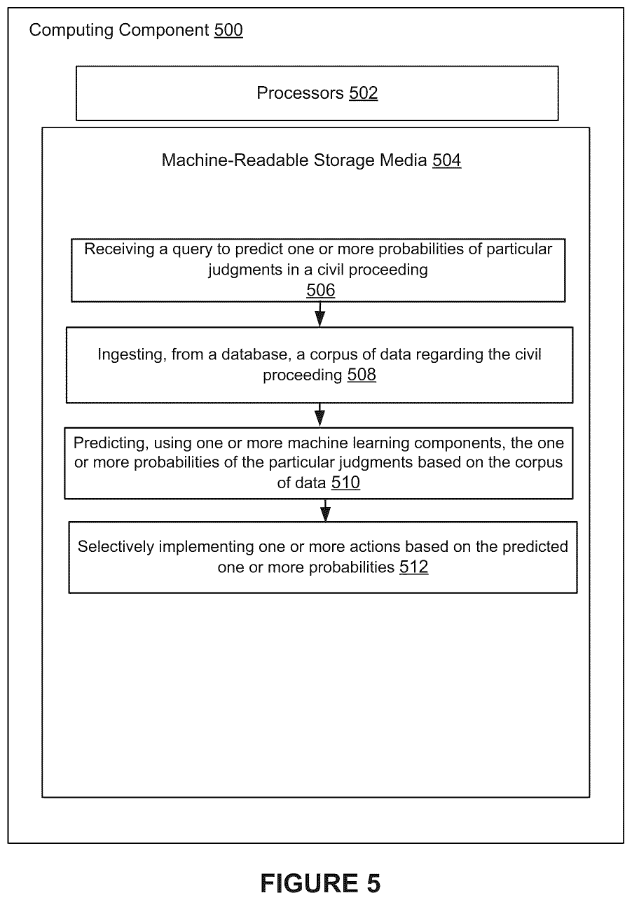

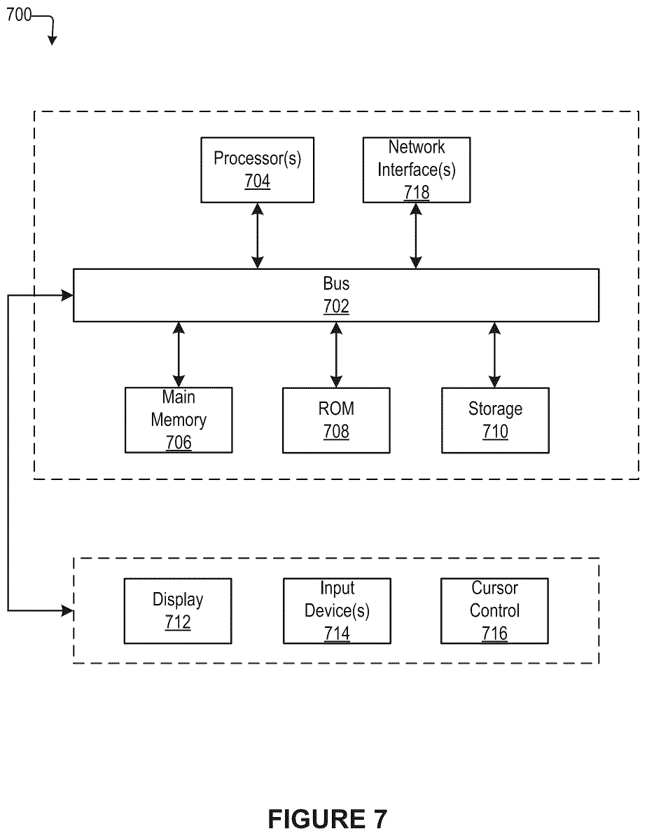

FIG. 5 illustrates a computing component 500 that includes one or more processors 502, either hardware (physical) or virtual (e.g., cloud based) and machine-readable storage media 504 storing a set of machine-readable/machine-executable instructions that, when executed, cause the processor(s) 502 to perform an illustrative method of monitoring and/or initiating of downstream actions. The computing component 500 may be implemented as the computing system 102 of FIG. 1. The processors 502 may be implemented as the processors 103 of FIG. 1. The machine-readable storage media 504 may be implemented as the machine-readable storage media 112 of FIG. 1, and may include suitable machine-readable storage media described in FIG. 7.

At step 506, the processor(s) 502 may execute machine-readable/machine-executable instructions stored in the machine-readable storage media 504 to receive a query to predict one or more probabilities of potential claim outcomes in a civil proceeding. This query may be received, for example, from the computing device 104 of FIG. 1.

At step 508, the processor(s) 502 may execute machine-readable/machine-executable instructions stored in the machine-readable storage media 504 to ingest, from a database (e.g., the database 130 in FIG. 1), a record of data regarding the civil proceeding.

At step 510, the processor(s) 502 may execute machine-readable/machine-executable instructions stored in the machine-readable storage media 504 to predict, using one or more machine learning components (e.g., the machine learning components 150 in FIG. 1, as hosted within the processors 103 or the computing system 102) the one or more probabilities of the potential claim outcomes based on the record of data.

At step 512, the processor(s) 502 may execute machine-readable/machine-executable instructions stored in the machine-readable storage media 504 to selectively implement one or more actions based on the predicted one or more probabilities. The one or more actions may be based on a suggestion (e.g., suggestions 170 and/or modified suggestions 270 in FIGS. 1 and 2A, respectively), and may include, for example, generating an alert or flag (e.g., the alert 172 or the modified alert 272 in FIGS. 1 and 2A, respectively), and/or initiating a communication (e.g., the communication 174 and/or the modified communication 174 in FIGS. 1 and 2A, respectively), if the probability of a verdict for the plaintiff, or of a nuclear verdict, exceeds some threshold.

FIG. 6 illustrates a summary of a process, in accordance with FIGS. 1, 2A, 2B, and 3-5. In FIG. 6, at step 602, one or more machine learning components to predict probabilities of one or more potential outcomes, such as nuclear verdicts, are created. The creation of the machine learning components may encompass training the machine learning components based on historical data which map previous data to occurrences of those potential outcomes, or non-occurrences of those potential outcomes. The historical data may have been within a previous time window, such as a previous ten years. The historical data may be further categorized, processed, and/or weighted. More recent historical data may be more heavily weighed compared to older data. As a nonlimiting example, the historical data may be divided into a number of segments (e.g., one year segments, two year segments) which may be a subset of the ten-year time window. A segment, or data within a segment, may be weighted according to a recency of the segment. For example, any data within a most recent segment, such as within a time period within a past year, may be weighted according to a first weight. Any data within a second most recent segment, older than the most recent segment, such as within a time period of between one and two years previously, may be weighted according to a second weight that is less than the first weight. Any data within a third most recent segment, older than the second most recent segment, may be weighted according to a third weight that is less than the second weight, and so forth. Such a division of segments may be propagated to or carried out on any remaining segments up to the oldest segment within the previous time window.

At step 604, the one or more machine learning components are deployed. A subset of the machine learning components may be selected for deployment based on a platform within the computing device 104, and/or based on data provided, for example, within the data 132. In some examples, an ensemble of machine learning components that combine features of different machine learning components may be deployed. At step 606, specific logic or protocols within the additional information generating engine 123 may be deployed to generate the additional information 270. At step 608, APIs (e.g., having the API endpoints 151 and 131, 161 and 141, 191 and 181, and others) are coded and deployed. At step 610, updated information, as manifested within the data 232, may be received within the computing device 104. This updated information may trigger an activation of the computing system 102 via an API call between the API endpoints 131 and 151, for example. At step 612, an updated prediction of one or more probabilities of the particular occurrences is generated, as manifested by the one or more updated probabilities 260, based on the updated information. At step 614, updated additional information is generated as a result of the updated prediction being transmitted to the additional information generating engine 123, which may occur via an API call between the API endpoints 181 and 191. At step 616, the updated prediction and the updated additional information may be transmitted to and rendered at the computing device 104. At step 618, the one or more machine learning components may be trained for improvement, as illustrated, for example, in FIG. 4. In some examples, certain machine learning components may be removed and replaced with new machine learning components. For example, certain machine learning components that have some performance measure (e.g. accuracy) below a threshold level may be removed.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software. Operating systems control and schedule computer processes for execution, perform memory management, provide file system, networking, I/O services, and provide a user interface functionality, such as a graphical user interface (“GUI”), among other things.

FIG. 7 is a block diagram that illustrates a computer system 700 upon which any of the embodiments described herein may be implemented. In some examples, the computer system 700 may include a cloud-based or remote computing system. For example, the computer system 700 may include a cluster of machines orchestrated as a parallel processing infrastructure. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may retrieves and executes the instructions. The instructions received by main memory 706 may optionally be stored on storage device 710 either before or after execution by processor 704.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

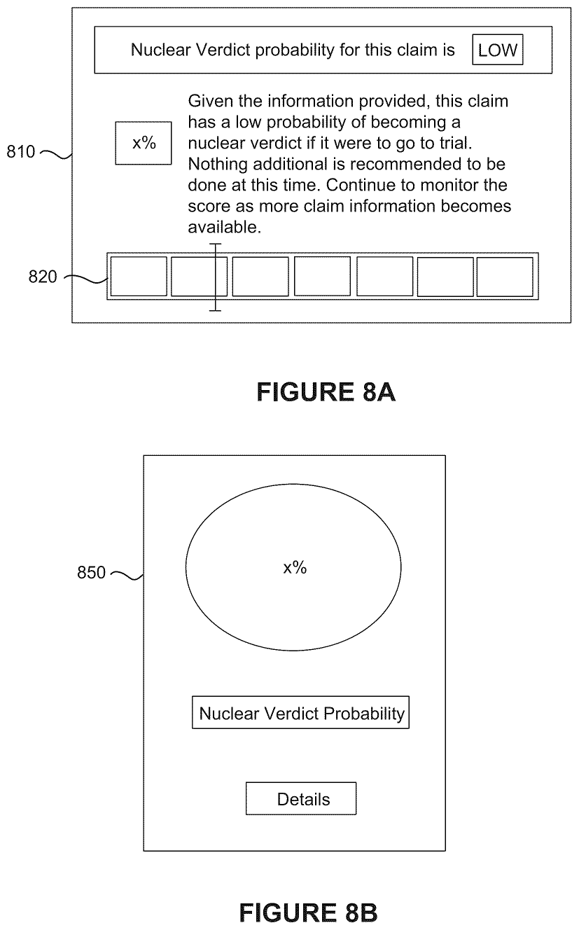

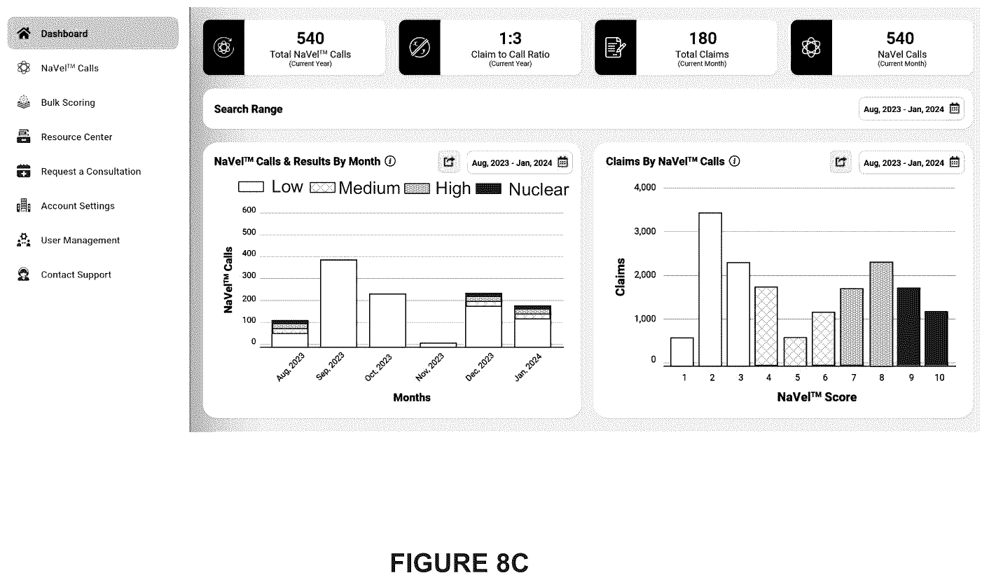

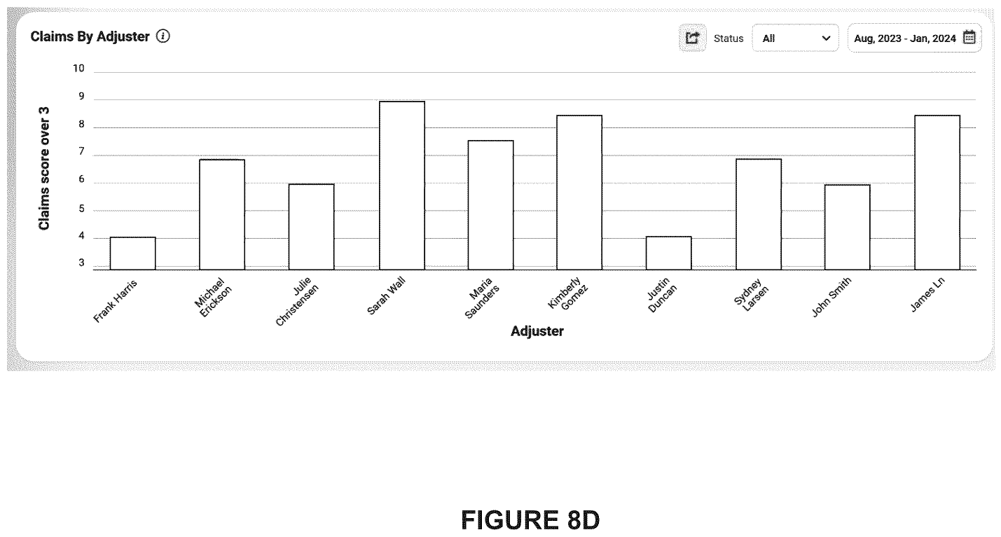

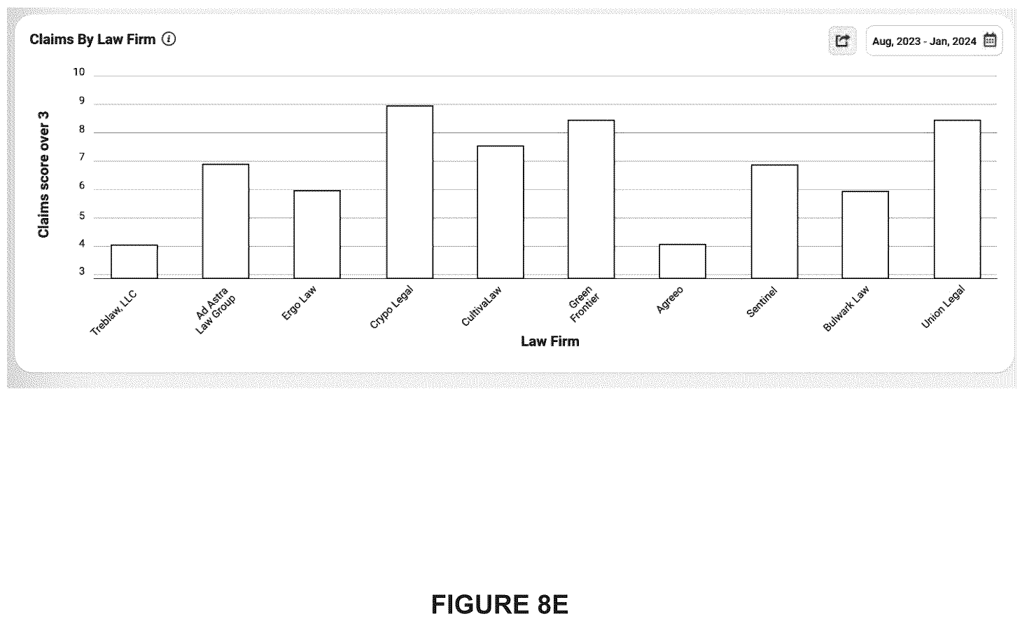

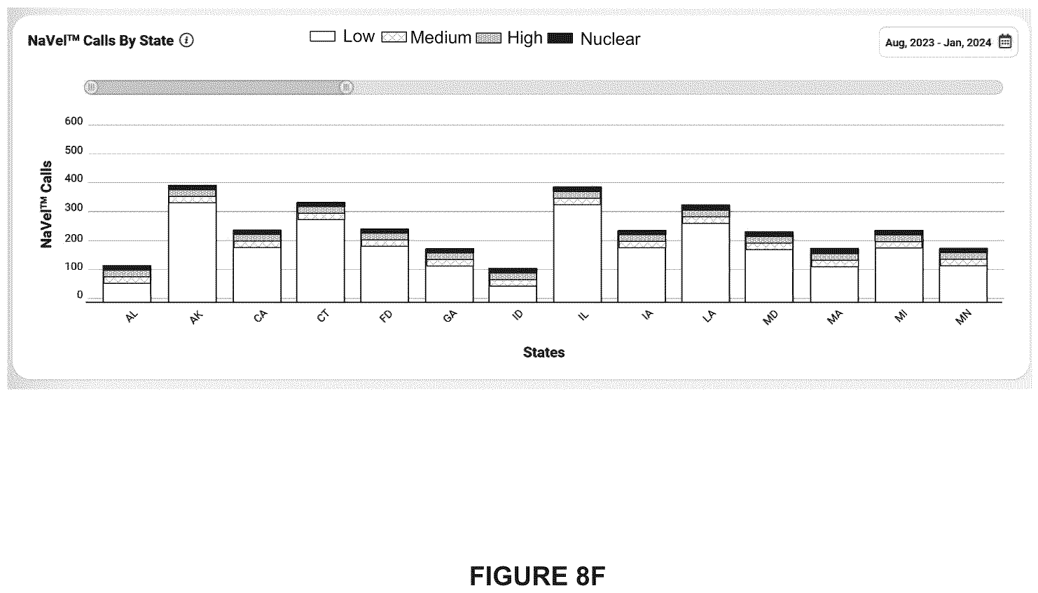

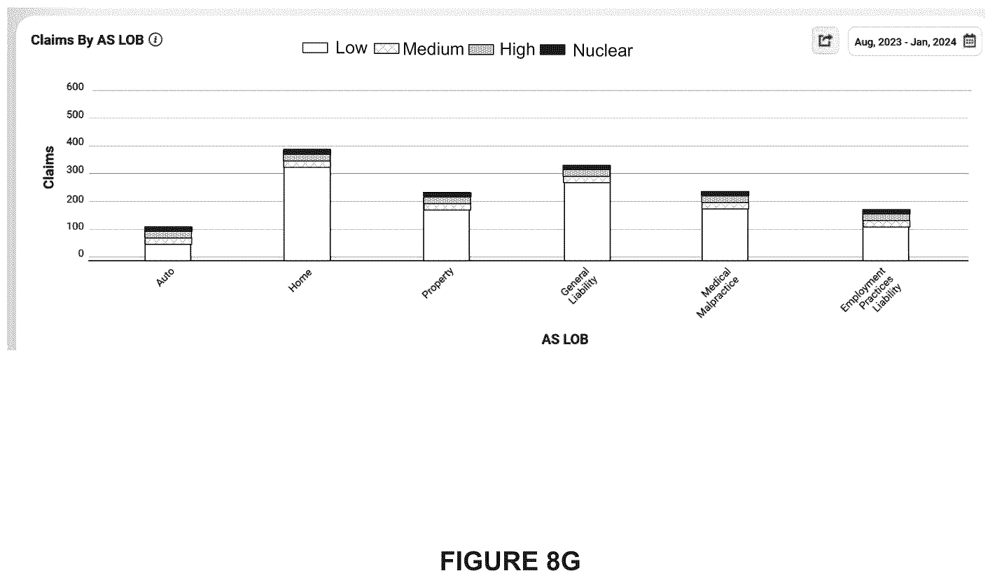

FIG. 8A illustrates an interface 810, in which one or more predictions regarding a probability of a claim resulting in a nuclear verdict is rendered. Additionally, one or more recommendations, such as a settlement, may be rendered, along with any estimated or predicted pecuniary consequences of a nuclear verdict or other verdict or judgment. The interface further includes a scale 820, such as a sliding scale, that pictorially displays a scale associated with the probability. In some examples, the probability may be converted into a probability score. For example, the probability score may be based on, or equivalent to, a cubic root of the probability. FIG. 8B displays an icon or badge 850 that depicts the probability. FIGS. 8C-8G display outputs of analytics and/or metrics corresponding to different claims. In particular, FIG. 8C includes a breakdown of number of claims based on a probability level of a nuclear verdict (e.g., low, medium, high and nuclear).

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be removed, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that “logic,” a “system,” “data store,” and/or “database” may comprise software, hardware, firmware, and/or circuitry. In one example, one or more software programs comprising instructions capable of being executable by a processor may perform one or more of the functions of the data stores, databases, or systems described herein. In another example, circuitry may perform the same or similar functions. Alternative embodiments may comprise more, less, or functionally equivalent systems, data stores, or databases, and still be within the scope of present embodiments. For example, the functionality of the various systems, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any figure or example can be combined with one or more features of any other figure or example. A component being implemented as another component may be construed as the component being operated in a same or similar manner as the another component, and/or comprising same or similar features, characteristics, and parameters as the another component.

The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to an “example” or “examples” means that a particular feature, structure or characteristic described in connection with the example is included in at least one example of the present invention. Thus, the appearances of the phrases “in one example” or “in some examples” in various places throughout this specification are not necessarily all referring to the same examples, but may be in some instances. Furthermore, the particular features, structures, or characteristics may be combined in any suitable manner in one or more different examples.

1. A system comprising:
one or more processors; and
a memory storing instructions that, when executed by the one or more processors, cause the system to perform:
receiving a query to predict one or more probabilities of potential claim outcomes;
ingesting, from a database, a record of data regarding a claim;
predicting, using one or more machine learning components, the one or more probabilities of the potential claim outcomes based on the record of data; and
selectively implementing one or more actions based on the predicted one or more probabilities.

2. The system of claim 1, wherein the one or more probabilities indicate a probability of a nuclear verdict in favor of a plaintiff, and the instructions that, when executed by the one or more processors, cause the system to perform:
outputting a confidence level of the prediction of the one or more probabilities and one or more indicators of the predicted one or more probabilities, the indicators comprising factors or reasons corresponding to the one or more probabilities.

3. The system of claim 1, wherein the one or more actions comprise triggering an alert or a flag for further investigation.

4. The system of claim 1, wherein the one or more actions comprise initiating a communication regarding a settlement and terms of the settlement to a different computing system associated with an opposing party.

5. The system of claim 1, wherein the machine learning components are trained sequentially by feeding, to the machine learning components, a first subset of data that comprises previously decided civil cases; and subsequently by feeding, to the machine learning components, additional data that comprises outcomes corresponding to the claim and other claims decided after the training using the first subset of data.

6. The system of claim 5, wherein the outcomes comprise scenarios in which the machine learning components predicted a nuclear verdict probability for a plaintiff in a particular civil proceeding, with at least a threshold probability or a threshold level, and an outcome of the particular civil proceeding was at least partially inconsistent with the prediction.

7. The system of claim 5, wherein the outcomes comprise scenarios in which the machine learning components predicted a nuclear verdict probability for a plaintiff in a particular civil proceeding, with less than a threshold probability or a threshold level, and an outcome of the particular civil proceeding was at least partially inconsistent with the prediction.

8. The system of claim 1, wherein the instructions further cause the system to perform:
determining fields within the record of data to concatenate based on respective positions of the fields; and
concatenating the fields, wherein the concatenating comprises combining text within the fields.

9. The system of claim 1, wherein the one or more probabilities comprise a probability score.

10. The system of claim 1, wherein the one or more probabilities indicate a probability of a non-nuclear verdict in favor of a defendant.

11. The system of claim 1, wherein the machine learning components comprise any of a boosted tree model, a decision tree, and a neural network.

12. A method comprising:
receiving a query to predict one or more probabilities of potential claim outcomes;
ingesting, from a database, a record of data regarding a claim;
predicting, using one or more machine learning components, the one or more probabilities of the potential claim outcomes based on the record of data; and
selectively implementing one or more actions based on the predicted one or more probabilities.

13. The method of claim 12, wherein the one or more probabilities indicate a probability of a nuclear verdict in favor of a plaintiff; and the method further comprises:
outputting a confidence level of the prediction of the one or more probabilities and one or more indicators of the predicted one or more probabilities, the indicators comprising factors or reasons corresponding to the one or more probabilities.

14. The method of claim 12, wherein the one or more actions comprise triggering an alert or a flag for further investigation.

15. The method of claim 12, wherein the one or more actions comprise initiating a communication regarding a settlement and terms of the settlement to a different computing system associated with an opposing party.

16. The method of claim 12, wherein the machine learning components are trained sequentially by feeding, to the machine learning components, a first subset of data that comprises previously decided civil cases; and subsequently using a second subset of data that comprises outcomes corresponding to the claim and other claims decided following the training using the first subset of data.

17. The method of claim 16, wherein the outcomes comprise scenarios in which the machine learning components predicted a nuclear verdict probability for a plaintiff in a particular civil proceeding, with at least a threshold probability or a threshold level, and an outcome of the particular civil proceeding was at least partially inconsistent with the prediction.

18. The method of claim 16, wherein the outcomes comprise scenarios in which the machine learning components predicted a nuclear verdict probability for a plaintiff in a particular civil proceeding, with less than a threshold probability or a threshold level, and an outcome of the particular civil proceeding was at least partially inconsistent with the prediction.

19. The method of claim 12, further comprising:
determining fields within the record of data to concatenate based on respective positions of the fields; and
concatenating the fields, wherein the concatenating comprises combining text within the fields.

20. The method of claim 12, wherein the one or more probabilities comprise a probability score.

21. The method of claim 12, wherein the one or more probabilities indicate a probability of a non-nuclear verdict in favor of a defendant.

22. The method of claim 12, wherein the machine learning components comprise any of a boosted tree model, a decision tree, a neural network, or other machine learning or artificial intelligence models.
